(19) United States
(12) Patent Application Publication
(10) Pub. No.: US 2010/0037695 A1
(43) Pub. Date: Feb. 18, 2010

(54) PHOTOACOUSTIC IMAGING APPARATUS

(76) Inventors: Kazuhiro TSUJITA, Kanagawa-ken (JP); Tadashi Kasamatsu, Kanagawa-ken (JP)

Correspondence Address: BIRCH STEWART KOLASCH & BIRCH, PO BOX 747, FALLS CHURCH, VA, 22040-0747, US

(21) Appl. No.: 12/540,820

(22) Filed: Aug. 13, 2009

(30) Foreign Application Priority Data
Aug. 14, 2008 (JP) 208809/2008

(51) Int. Cl. G01B 11/24; G01H 17/00; G01B 17/06

(52) U.S. Cl. 73/587; 702/167; 356/601

(57) ABSTRACT

A photoacoustic imaging apparatus is equipped with: light generating means, for emitting measuring light; light irradiating means, for irradiating the measuring light onto a target; ultrasound detecting means, for detecting ultrasonic waves which are generated in the target portion by the irradiation of the measuring light; and tomographic image obtaining means, for obtaining a tomographic image of the target based on signals of the detected ultrasonic waves. The light generating means includes a pulse laser and light modulating means, which are employed to emit a pulse train having a plurality of pulse beams having pulse widths within a range from 1 nsec to 100 nsec as the measuring light. The tomographic image obtaining means generates processed signals by performing a correlating process between transmission signals of the pulse train and the signals of the ultrasonic waves, and obtains the tomographic image of the target based on the processed signals.

### BACKGROUND OF THE INVENTION

1. Field of the Invention

The present invention is related to a photoacoustic imaging apparatus that collects acoustic waves (ultrasonic waves) which are generated based on the energy of light irradiated onto a target portion, and generates images of tissue information of the target portion.

2. Description of the Related Art

Various types of optical measuring devices are conventionally utilized in the field of tissue measurement. These optical measuring devices irradiate measuring light beams (such as near infrared light) onto living tissue from the exteriors of bodies, and detect signals of light or sound waves which are output via interactions between the measuring light beams and the living tissue. Tomographic image data is generated, and physiological data (the quantitative amount of hemoglobin, for example) is collected, based on the detected signals that include information regarding the living tissue. As examples of such a measuring device, there are those that perform multiple wavelength photoacoustic analysis as disclosed in Japanese Unexamined Patent Publication Nos. 6(1994)-296612 and 2003-290126, and U.S. Pat. No. 6,979,292. Multiple wavelength photoacoustic analysis is a method takes advantage of the fact that when visible light, near infrared light, or middle infrared light having predetermined wavelengths are irradiated onto target portions as measuring light (pulse light), specific substances such as glucose and hemoglobin, which are included in blood within the target portion, absorb a portion of the energy of the pulse light (an amount of energy per each pulse). Specifically, the specific substance absorbing the portion of the energy of the pulse light results in acoustic waves (ultrasonic waves) being generated due to adiabatic expansion of the living tissue within the target portion. The acoustic waves are detected to measure the concentration of the specific substance, the shape of the living tissue, and the like.

However, in the aforementioned conventional photoacoustic imaging apparatuses, there is a problem that the image construction speed in order to obtain a single two dimensional tomographic image is slow. Specifically, even in apparatuses that have comparatively high image construction speeds as reported at academic meetings, the image construction speed between irradiation of pulse light to display of a single image is approximately one second (1 frame/sec). At this image construction speed, it is difficult to avoid the influence of the movements of subjects, and the influence of movements of target organs accompanying respiration, heartbeat, and the like. That is, this image construction speed is not sufficient for clinical applications. Accordingly, it is necessary to accelerate image construction speed further, to realize a photoacoustic imaging apparatus suited for clinical use.

A simple solution to the above problem would be to increase the number of repetitions of the irradiation of pulse light per unit time. Thereby, the number of ultrasonic waves which become detectable per unit time increases, and the image construction speed can be accelerated.

However, adopting this method would cause a problem that the power of the measuring light (the average intensity of measuring light over time) increases. Nanosecond laser pulse light having high energy density (approximately mJ/cm²) and high output is employed in conventional photoacoustic imaging apparatuses, in order to obtain images of living tissue, which has high light scattering properties. For this reason, if the number of repetitions of the irradiation of pulse light is simply increased in order to improve the image construction speed, the power of the measuring light becomes greatly increased. This will lead to the photoacoustic imaging apparatuses becoming larger and more expensive, and there may be cases in which living tissue is damaged by the high powered measuring light. The increase in the power of the measuring light may be suppressed by employing nanosecond laser pulse light having high energy density and low output. However, it is difficult to obtain high power from laser diodes (LD's), light emitting diodes (LED's), and He—Ne lasers as disclosed in Japanese Unexamined Patent Publication No. 2003-290126. In addition, optical parametric oscillators (OPO's) are costly and have unstable output.

### SUMMARY OF THE INVENTION

The present invention has been developed in view of the foregoing circumstances. It is an object of the present invention to provide a low cost photoacoustic imaging apparatus that exhibits performance suited for clinical applications.

A photoacoustic imaging apparatus of the present invention comprises: a light generating means, for emitting a measuring light beam; a light irradiating means, for irradiating the measuring light beam onto a target portion; an ultrasound detecting means, for detecting ultrasonic waves which are generated in the target portion due to the irradiation of the measuring light beam; and tomographic image obtaining means, for obtaining a tomographic image of the target portion based on signals of the ultrasonic waves which are detected by the ultrasound detecting means. The photoacoustic imaging apparatus of the present invention is characterized by: the light generating means comprising a laser pulse light source and light modulating means; the light generating means employing the laser pulse light source and the light modulating means to emit a pulse train having a plurality of pulse beams having pulse widths within a range from 1 nsec to 100 nsec as the measuring light beam; and the tomographic image obtaining means generating processed signals by performing a correlating process between transmission signals of the pulse train and the signals of the ultrasonic waves, and obtaining the tomographic image of the target portion based on the processed signals.

Here, the “processed signals” refers to signals that represent correlative values, generated as a result of the correlating process which is administered by the tomographic image obtaining means onto the transmission signals and the detected signals of the ultrasonic waves. For example, the correlative values obtained by convolution integrating the detected signals, which are functions of a delay time t, and the transmission signals.

In the photoacoustic imaging apparatus of the present invention, it is preferable for the laser pulse light source to be a semiconductor laser pulse light source, and for the light modulating means to comprise laser control means for controlling the semiconductor laser pulse light source and light amplifying means for amplifying light which is generated by the semiconductor laser pulse light source. In this case, it is preferable for the light amplifying means to be an optical fiber amplifier. It is preferable for the optical fiber amplifier to be one of an ytterbium doped optical fiber amplifier and an erbium doped optical fiber amplifier.

Alternatively, the laser pulse light source may be a solid state laser pulse light source; and the light modulating means may comprises dividing means for dividing a single pulse light beam emitted by the solid state laser pulse light source into a number of pulse light beams which is the same as the bit number of the pulse train, delay means for delaying each of the divided pulse light beams for different amounts of time, shielding means capable of shielding each of the divided pulse light beams, and combining means for combining the divided and delayed pulse light beams. In this case, it is preferable for the solid state laser pulse light source to be one of the Q switch type and the gain switch type.

The photoacoustic imaging apparatus of the present invention is equipped with the light generating means that emits a pulse train having a plurality of pulse beams having pulse widths within a range from 1 nsec to 100 nsec, and the tomographic image obtaining means that performs a correlating process between transmission signals of the pulse train and the detected signals of the ultrasonic waves. The use of the pulse train improves the S/N ratio of measurement, without the need for a high energy pulse light. Commonly, wave trains of ultrasonic waves which are generated within target portions become longer when long pulse trains are employed, and therefore resolution in the depth direction deteriorates. However, the deterioration in resolution can be suppressed by performing the correlating process between the transmission signals and the detected signals. Accordingly, the S/N ratio and image construction speed can be improved by use of an inexpensive light source that emits low output nanosecond laser pulse light beams, without the need for an expensive light source such as an OPO. As a result, it becomes possible to realize a low cost photoacoustic imaging apparatus that exhibits performance suited for clinical applications.

### BRIEF DESCRIPTION OF THE DRAWINGS

FIG. 1 is a schematic view that illustrates an example of a PAI apparatus according to the present invention.

FIG. 2A is a diagram that illustrates a first example of a modulated pulse train.

FIG. 2B is a diagram that illustrates a second example of a modulated pulse train.

FIG. 3 is a schematic diagram that illustrates a correlating process administered on transmission signals and detected signals.

FIG. 4 is a schematic diagram that illustrates the construction of a light generating means according to a first embodiment of the present invention.

FIG. 5A is a schematic diagram that illustrates the construction of a first laser pulse light source of a light generating means according to a second embodiment of the present invention.

FIG. 5B is a schematic diagram that illustrates the construction of a second laser pulse light source of the light generating means according to the second embodiment of the present invention.

FIG. 6 is a schematic diagram that illustrates the construction of a first delay interleave optical circuit of the light generating means according to the second embodiment of the present invention.

FIG. 7A is a schematic diagram that illustrates the construction of a second delay interleave optical circuit of the light generating means according to the second embodiment of the present invention.

FIG. 7B is a schematic diagram that illustrates the construction of a third delay interleave optical circuit of the light generating means according to the second embodiment of the present invention.

### DESCRIPTION OF THE PREFERRED EMBODIMENTS

Embodiments of the present invention will be described hereinafter. However, the present invention is not limited to the embodiments described below.

### <Photoacoustic Imaging Apparatus>

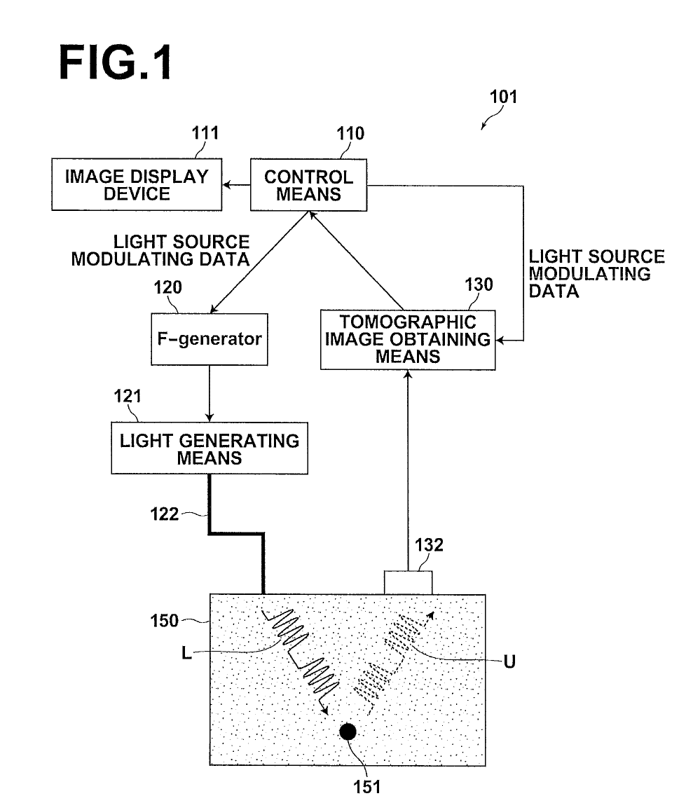

Photoacoustic imaging (PAI) apparatuses according to embodiments of the present invention will be described. FIG. 1 is a schematic view that illustrates the entirety of a PAI apparatus 101 according to a first embodiment of the present invention.

As illustrated in FIG. 1, the PAI apparatus 101 is equipped with: a control means 110, for controlling the apparatus; a function generator (FG) 120, for receiving light source modulating data from the control means 110 and for driving a light generating means based on the light source modulating data; the light generating means 121, for emitting a measuring light beam L; an optical fiber 122, which functions as a light irradiating means for irradiating the measuring light beam L onto a target portion 150 of an organism (light scattering/absorbing medium); an ultrasonic wave detecting means 132, for detecting ultrasonic waves U which are generated by living tissue 151 within the target portion 150 due to the irradiation of the measuring light beam L; a tomographic image obtaining means 130, for receiving signals of the ultrasonic waves U from the ultrasonic wave detecting means 132, for administering a correlating process on the received signals, and for obtaining a tomographic image of the target portion 150 based on the processed received signals; and an image display device 111, for displaying the obtained tomographic image.

The control means 110 controls the contents of operation of each of the components of the apparatus, as well as the timings of each of the operations.

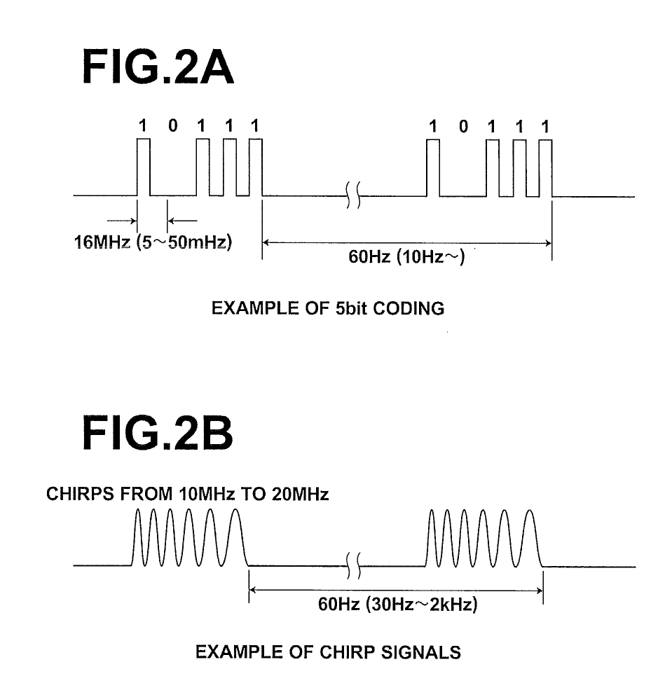

The light generating means 121 comprises a laser pulse light source and a light modulating means. The light generating means 121 employs the laser pulse light source and the light modulating means to emit a pulse train having a plurality of pulse beams having pulse widths within a range from 1 nsec to 100 nsec as the measuring light beam. The range of pulse widths is determined from the viewpoint of causing the ultrasonic waves U to be efficiently generated within the target portion 150. It is preferable for the wavelength of the measuring light beam L to be within a range from 700 nm to 900 nm, from the viewpoint of being capable of reaching deep portions within the target portion. It is preferable for the output of the measuring light beam L to be within a range from 10 μJ to several 10's of mJ's, from the viewpoints of propagation loss of light and ultrasonic waves, the light to ultrasonic wave conversion efficiency, and the detection sensitivities of current detectors. Further, it is preferable for the repetitions of irradiation of the pulse light beams to be 10 Hz or greater, from the viewpoint of improving image construction speed. Meanwhile, although not particularly limited, the aforementioned pulse train is constituted by modulated signals, such as coded signals having data of 0 or 1 as illustrated in FIG. 2A, or by chirp signals, of which the repetition frequency varies over time, as illustrated in FIG. 2B. The type of modulated signals to be employed may be selected appropriately according to measuring conditions, the light source to be employed, and the like. Note that the construction of the light generating means 121 including the laser pulse light source and the light modulating means will be described in detail later.

The light irradiating means 122 guides the measuring light beam L emitted from the light generating means 121 to the target portion 150. It is preferable to employ optical fibers or optical waveguide paths as the light irradiating means 122, in order to perform efficient light guiding.

The ultrasonic wave detecting means 132 is a single oscillator or an oscillator array. The ultrasonic wave detecting means 132 is a piezoelectric element, such as a piezoelectric ceramic or a polymer film, such as polyvinyl pyrrolidone.

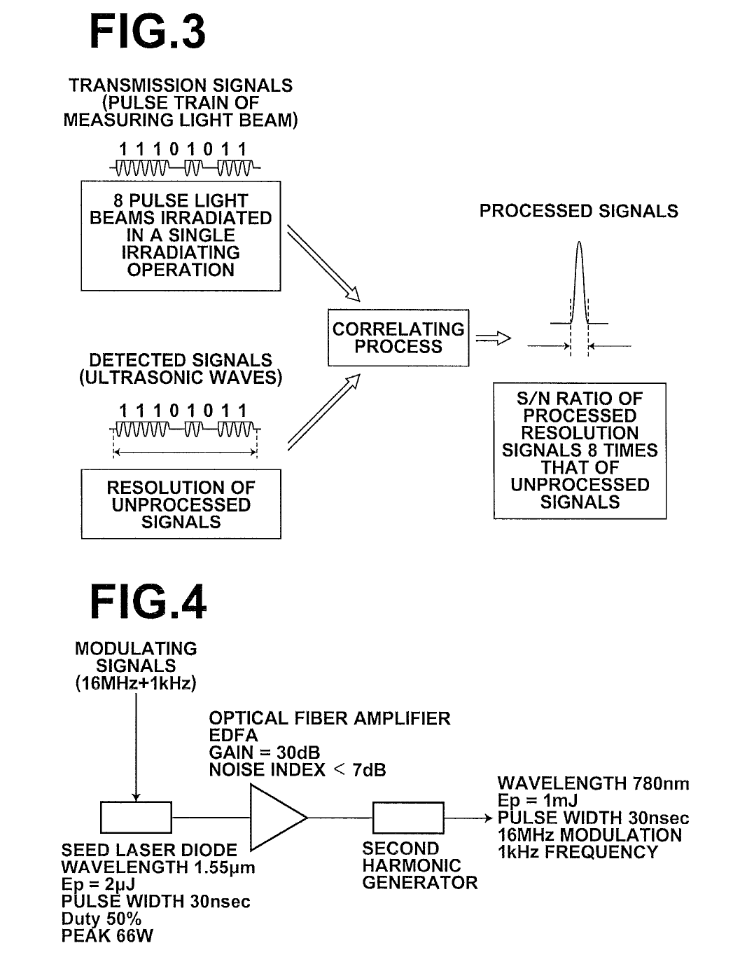

The tomographic image obtaining means 130 generates tomographic images based on the received signals, and transmits the generated tomographic images to the control means 110. More specifically, the tomographic image obtaining means 130 performs a correlating process between transmission signals of the irradiated pulse train L and the signals of the ultrasonic waves U which are generated within the target portion 150 due to the irradiation of the pulse train L, obtains tomographic data regarding the target portion 150 based on the processed signals, and generates tomographic images based on the tomographic data. The tomographic images may be generated based on correlative values obtained by convolution integrating the detected signals and the transmission signals. The light source modulating data which is sent to the FG 120 from the control means 110 may be employed as the transmission signals. Alternatively, signals regarding the pulse train L, which are detected by a photodetector or the like, may be employed as the transmission signals. As described above, wave trains of ultrasonic waves which are generated within the target portion 150 become longer when pulse trains are employed, and therefore resolution in the depth direction deteriorates. However, the S/N ratio can be improved and the deterioration in resolution can be suppressed by performing the correlating process between the transmission signals and the detected signals, thereby measuring the time delay of the detected signals with respect to the transmission signals, as illustrated in FIG. 3. Note that the signal processes administered by the tomographic image obtaining means 130 will be described in detail later.

The image display device 111 displays tomographic images which are transmitted thereto from the control means 110.

PAI measurement that employs the PAI apparatus 101 of the first embodiment will be described below. First, a pulse train L, in which a plurality of pulse light beams are arrayed, is irradiated onto the target portion 150 as the measurement light beam. The ultrasonic waves U which are generated within the target portion 150 due to the irradiation of the pulse train L thereon are detected by the ultrasonic wave detecting means 132. Then, the tomographic image obtaining means 130 performs the correlating process between the detected signals of the ultrasonic waves U and the transmission signals of the pulse train L. The correlative values which are generated by the correlating process are designated as processed signals. A tomographic image corresponding to a single line is obtained based on the processed signals. Thereafter, the above operations are repeated while scanning along a measurement area within the target portion 150, to obtain tomographic images corresponding to a plurality of lines. The tomographic images corresponding to the plurality of lines are integrated, to obtain a tomographic image of the target portion 150.

The signal processes administered onto the detected signals by the tomographic image obtaining means 130 is that which is described below, for example. First, an STC (Sensitivity Time Control) process is administered onto the received signals of the ultrasonic waves U, which are detected by the ultrasonic wave detecting means 132. Thereby, the sensitivity (gain) is adjusted according to time (depth). In the case that pluralities of measurements are performed at the same locations, the analog signals obtained by each measurement are summed. For example, in the case that ten measurements are performed, the ten measured values which are obtained at each measurement are summed. In this case, the S/N ratio can be improved further. Next, A/D conversion is performed, followed by the aforementioned correlating process. The correlative values (the processed signals) obtained by the correlating process are converted into signal intensities, and the temporal axis (t) is converted into a displacement axis (v·t), to obtain the tomographic image corresponding to a single line. Then, the tomographic images corresponding to the plurality of lines are obtained as described above, and the tomographic images corresponding to the plurality of lines are integrated, to obtain the tomographic image of the target portion 150.

Hereinafter, the structure of the light generating means 121 that emits the pulse train L, in which a plurality of pulse light beams having pulse widths within a range from 1 nsec to 100 nsec are arrayed, will be described. There are two basic principles for generating the pulse train L.

The first is a light generating means constituted by a laser pulse light source which is capable of modulating the energy of pulse light beams, and light amplifying means for amplifying light which is generated by the laser pulse light source (first embodiment). That is, the light generating means 121 of the first embodiment emits a pulse train having low energy using a laser pulse light source which is capable of modulating the pulse light beams. Then, the energy of the pulse train is amplified, to obtain a desired pulse train L. At this time, the FG 120 functions as the light modulating means for modulating the measuring light beam L. The light generating means 121 of the first embodiment is capable of modulating the pulse light beams in a simple manner. Therefore, the light generating means 121 of the first embodiment can be employed favorably in cases that chirp signals are employed as the pulse train, and in cases that measurement is performed at low energy and a high number of repetitions.

The second is a light generating means constituted by a laser pulse light source that emits a single high energy pulse light beam, a dividing means for dividing the single pulse light beam into a plurality of pulse light beams, delay means for delaying each of the divided pulse light beams for different amounts of time, shielding means capable of shielding each of the divided pulse light beams, and combining means for combining the divided and delayed pulse light beams (second embodiment) That is, the light generating means 121 according to the second embodiment obtains a desired pulse train L by: emitting a single high energy pulse light beam; dividing the pulse light beam into a plurality of pulse light beams; delaying each of the divided pulse light beams by different amounts of time; shielding unnecessary pulse light beams during the delaying process; and combining the divided and delayed pulse light beams. At this time, the dividing means, the delay means, the delay means, the shielding means, and the combining means (delay interleave optical circuit) function as the light modulating means for modulating the measuring light beam L. The light generating means 121 according to the second embodiment can shield selected pulse light beams from among the divided pulse light beam, and therefore can be favorably employed in cases that coded signals are employed as the pulse light beams.

Hereinafter, specific examples of the light generating means according to the first embodiment and the second embodiment will be described. Note that the light generating means is not limited to the following embodiments.

### First Embodiment of the Light Generating Means

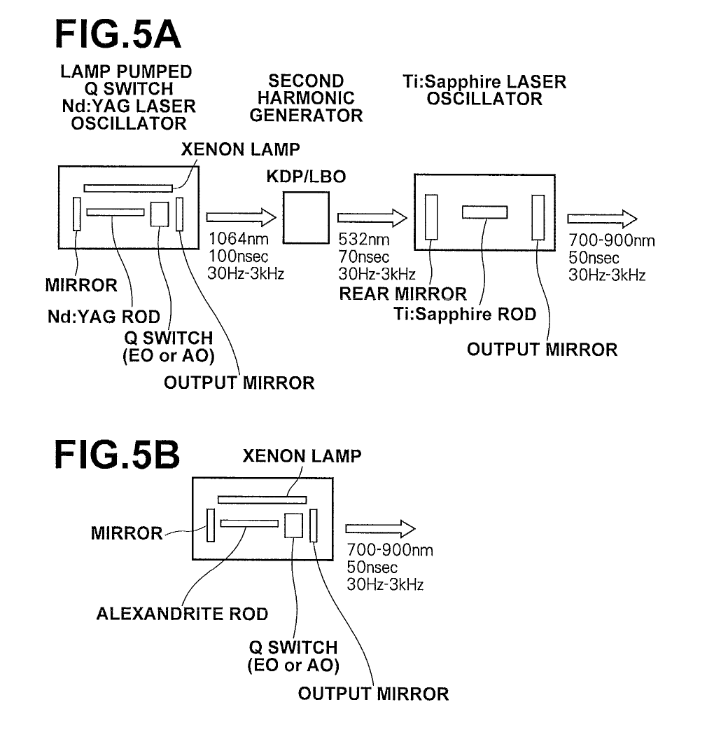

As illustrated in FIG. 4, in the light generating means of the first embodiment, first, a low output semiconductor laser pulse light source (Ep=2 μJ, pulse width 30 nsec, repetition frequency 16 MHz, duty=50%, peak power 66 W, wavelength 1.55 μm) emits a modulated low energy pulse train. Then, current modulation is applied to the semiconductor laser pulse light source, and a desired waveform (pulse train) is generated in a simple manner. Next, the pulse train is optically amplified in a double cladded EDFA (Erbium Doped Fiber Amplifier) at a gain of 30 dB. An mJ class pulse train having a wavelength of 780 nm can be obtained by applying SHG after the peak power is optically amplified to approximately 30 kW, and the energy of each of the pulse light beams within the pulse train is optically amplified to at least an mJ. Note that if 4 bit=4 mJ×1.5 kHz, it is possible to realize saturated output of the optical fiber amplifier, at an average output of 6 W.

### Second Embodiment of the Light Generating Means

The light generating means of the second embodiment is basically constituted by a laser pulse light source that emits a single high energy pulse light beam, and a delay interleave optical circuit.

First, the laser pulse light source will be described. The properties required of the laser pulse light source are: a wavelength within a range from 700 nm to 900 nm; a pulse light energy Ep within a range from 10 μJ to several 10's of mJ's; pulse widths within a range from 10 nsec to 100 nsec; and a repetition frequency within a range from 30 Hz to 3 kHz. In view of the required pulse widths, a Q switch type solid state laser or a gain switch type solid state laser is most suited for this application. This is because in normal mode operation by pulse pumping, pulse widths are at most approximately a μsec due to relaxation oscillation of laser crystals, and on the other hand, in mode locked operation, pulse widths are within a range from psec's to fsec's. A method may be considered in which a light emitted from a pulse operation seed light source is amplified by an optical fiber amplifier. However, it is considered that the Q switch type solid state laser is optimal, from the viewpoint of cost.

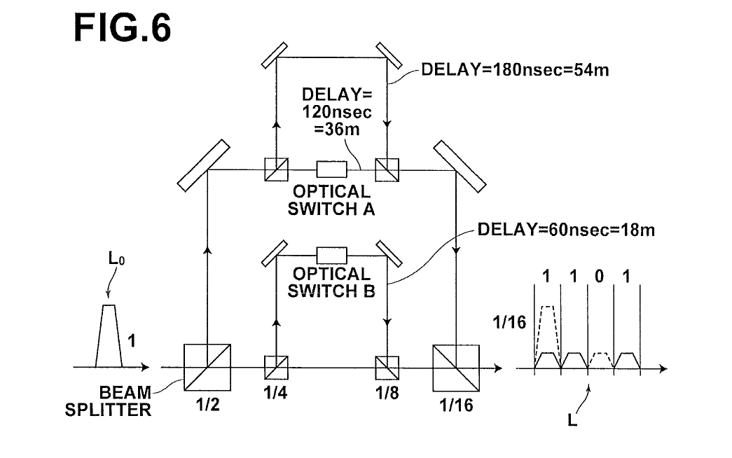

FIG. 5A is a schematic diagram that illustrates the construction of the laser pulse light source. First, a laser beam (1064 nm) output by a lamp pumped Q switch Nd:YAG laser is converted to the second harmonic waves (532 nm) at the exterior of a resonator. The second harmonic waves (532 nm) are used as pumping light, to pump a Ti:Sapphire crystal. An electro optical (EO) Q switch may be employed in cases that the repetition frequency is up to 1 kHz, and an acoustic optical (AO) Q switch may be employed in cases that the repetition frequency exceeds 1 kHz. In the Ti:Sapphire laser oscillator, the Ti:Sapphire is provided within a linear resonator. In addition, in the Ti:Sapphire laser oscillator, the mirror toward the rear is non reflective (reflectance R<5%) with respect to the pumping light, and totally reflective (R>99.9%) with respect to the oscillated light. An output mirror is partially reflective (R=approximately 80%). By setting the mirror reflectances of the Ti:Sapphire laser oscillator such that the reflectance is decreased (R<50%) with respect to light having wavelengths other than preferred wavelengths, desired wavelengths within a laser gain band can be output without inserting a wavelength selecting element within the resonator. If the output of the Nd:YAG laser oscillator is 100 mJ (50 mJ following SHG conversion), an output of approximately 10 mJ from the Ti:Sapphire laser oscillator is possible. Accordingly, 100 mJ×100 Hz=average output 10 W is sufficiently realizable by a lamp pumped structure.

As an alternate construction, a flash lamp pumped Q switch alexandrite laser such as that illustrated in FIG. 5B may be considered. The duration of an upper level of alexandrite is equivalent to that of Nd:YAG, at 250 μsec, and flash lamp pumping thereof is possible using a common power source. In this case, a simpler structure than that described above can be employed to realize pulse light beams having energy of 10 mJ or greater and wavelengths within a range from 730 nm to 800 nm.

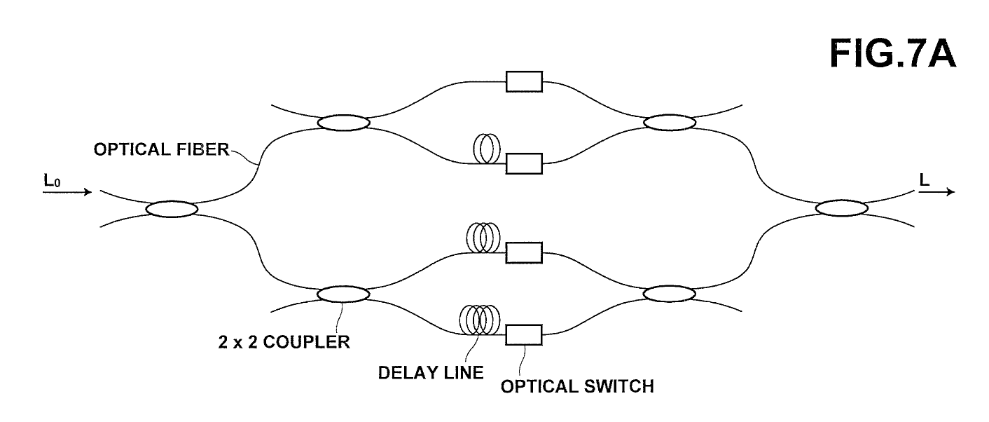

Next, the delay interleave optical circuit will be described. The delay interleave optical circuit illustrated in FIG. 6 repeatedly performs halving using half beam splitters of a bulk optical system. This delay interleave optical circuit is equipped with optical switches which are capable of shielding pulse light beams as desired, provided along the optical paths of the divided pulse light beams, to enable coding of signals by turning the optical switches ON and OFF. The delay interleave optical circuit illustrated in FIG. 6 can generate 4 bit coded signals. For example, in the delay interleave optical circuit illustrated in FIG. 6, optical switch A is in the OFF state, and optical switch B is in the ON state. Therefore, a pulse train L having a bit with a value of 0 at the second form right bit among the four bits illustrated in the figure is output. Note that the energy of each pulse light beam of the pulse train L is 1/16 the energy of an input pulse light beam L₀. Therefore, the energy of the input pulse light beam L₀ may be set to be 16 times that of each pulse light beam of a desired pulse train L.

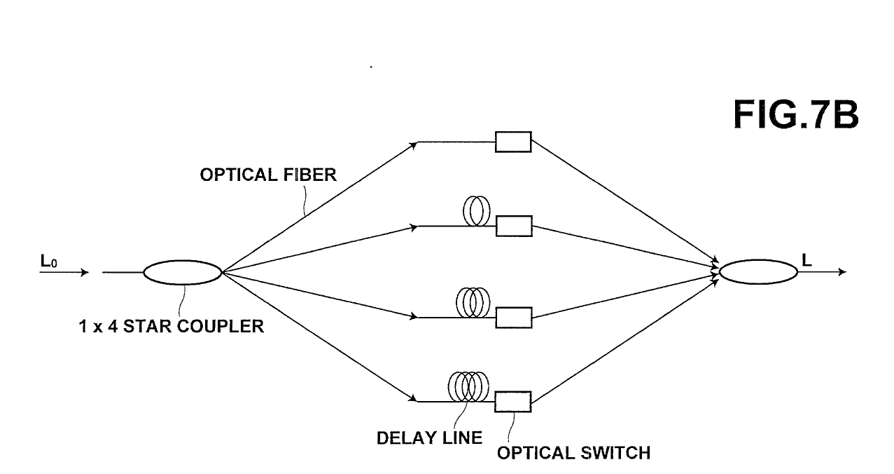

As an alternative, an optical fiber system may be employed instead of the bulk optical system, to form a more compact structure which is applicable to general use. Specifically, the dividing and combining functions of beam splitters can be realized by connecting a plurality of multi mode 3 dB 2×2 couplers, as illustrated in FIG. 7A. As a further alternative, it is possible to employ a 1×N star coupler, as illustrated in FIG. 7B. Optical shutters that utilize Mach Zehnder type LiNbO₃ or light absorbers may be employed as the optical switches.

As described above, the light generating means of the second embodiment can be realized by the Q switch laser pulse light source as illustrated in FIG. 5A or FIG. 5B and the delay interleave optical circuit as illustrated in any one of FIG. 6, FIG. 7A, and FIG. 7B.

As described above, the PAI apparatus according to the present invention is equipped with the light generating means that emits a pulse train having a plurality of pulse beams having pulse widths within a range from 1 nsec to 100 nsec, and the tomographic image obtaining means that performs a correlating process between transmission signals of the pulse train and the detected signals of the ultrasonic waves. The use of the pulse train improves the S/N ratio of measurement, without the need for a high energy pulse light. Commonly, wave trains of ultrasonic waves which are generated within target portions become longer when long pulse trains are employed, and therefore resolution in the depth direction deteriorates. However, the deterioration in resolution can be suppressed by performing the correlating process between the transmission signals and the detected signals. Accordingly, the S/N ratio and image construction speed can be improved by use of an inexpensive light source that emits low output nanosecond laser pulse light beams, without the need for an expensive light source such as an OPO. As a result, it becomes possible to realize a low cost photoacoustic imaging apparatus that exhibits performance suited for clinical applications.

What is claimed is:

1. A photoacoustic imaging apparatus, comprising:
a light generating means, for emitting a measuring light beam;
a light irradiating means, for irradiating the measuring light beam onto a target portion;
an ultrasound detecting means, for detecting ultrasonic waves which are generated in the target portion due to the irradiation of the measuring light beam; and
tomographic image obtaining means, for obtaining a tomographic image of the target portion based on signals of the ultrasonic waves which are detected by the ultrasound detecting means,
the light generating means comprising a laser pulse light source and light modulating means;
the light generating means employing the laser pulse light source and the light modulating means to emit a pulse train having a plurality of pulse beams having pulse widths within a range from 1 nsec to 100 nsec as the measuring light beam; and
the tomographic image obtaining means generating processed signals by performing a correlating process between transmission signals of the pulse train and the signals of the ultrasonic waves, and obtaining the tomographic image of the target portion based on the processed signals.

2. A photoacoustic imaging apparatus as defined in claim 1, wherein:
the laser pulse light source is a semiconductor laser pulse light source; and
the light modulating means comprises laser control means for controlling the semiconductor laser pulse light source and light amplifying means for amplifying light which is generated by the semiconductor laser pulse light source.

3. A photoacoustic imaging apparatus as defined in claim 2, wherein:
the light amplifying means is an optical fiber amplifier.

4. A photoacoustic imaging apparatus as defined in claim 3, wherein:
the optical fiber amplifier is one of an ytterbium doped optical fiber amplifier and an erbium doped optical fiber amplifier.

5. A photoacoustic imaging apparatus as defined in claim 1, wherein:
the laser pulse light source is a solid state laser pulse light source; and
the light modulating means comprises dividing means for dividing a single pulse light beam emitted by the solid state laser pulse light source into a number of pulse light beams which is the same as the bit number of the pulse train, delay means for delaying each of the divided pulse light beams for different amounts of time, shielding means capable of shielding each of the divided pulse light beams, and combining means for combining the divided and delayed pulse light beams.

6. A photoacoustic imaging apparatus as defined in claim 5, wherein:
the solid state laser pulse light source is one of the Q switch type and the gain switch type.
